(19) United States
(12) Patent Application Publication
(10) Pub. No.: US 2025/0299498 A1
(43) Pub. Date: Sep. 25, 2025

(54) AUTOMATIC PARKING SPACE NOTIFICATION SYSTEM

(71) Applicant: CARIAD (CHINA) CO., LTD., Beijing (CN)

(72) Inventors: Yuheng YIN, Beijing (CN); Tong QU, Beijing (CN)

(21) Appl. No.: 19/086,010

(22) Filed: Mar. 20, 2025

(30) Foreign Application Priority Data
Mar. 22, 2024 (CN) 202420573493.7

(51) Int. Cl. G06V 20/58; G06V 20/62; G08G 1/14; H04W 4/80

(52) U.S. Cl. CPC G06V 20/586; G08G 1/143; H04W 4/80; G06V 20/62

(57) ABSTRACT

Provided is an automatic parking space notification system, comprising: a visual information acquisition module disposed on a motor vehicle, configured to visually acquire and transmit parking space information; a first short-range wireless communication module disposed on the motor vehicle, configured to receive and transmit the parking space information transmitted by the visual information acquisition module; and a second short-range wireless communication module disposed on a mobile device, configured to establish a wireless communication connection with the first short-range wireless communication module, receive the parking space information transmitted by the first short-range wireless communication module, and store the parking space information in the mobile device. The automatic parking space notification system according to the present disclosure enables the automatic acquisition, identification, and transmission of parking space information, which not only enhances the convenience and efficiency for drivers, but also effectively reduces the development, construction, and maintenance costs of a parking lot.

### TECHNICAL FIELD

The present disclosure relates to a motor vehicle parking notification system, and particularly, to an automatic parking space notification system.

### BACKGROUND

With the development of society and the advancement of technology, people's demand for large parking lots is continuously increasing. However, drivers often struggle to locate their vehicles in large parking lots due to forgetting to record the parking space ID. To solve such a problem, some large parking lots install parking space notification systems. In the prior art, parking space notification systems are typically designed based on parking lots, such as parking lot management systems, which require the installation of a plurality of sensors (cameras, geomagnetic sensors, roof-mounted radars, lidars, etc.) within the parking lot. Drivers need to pre-register for the parking space notification service of the parking lot. Once a driver parks the vehicle in one of the parking spaces, the system sends the corresponding parking space ID to the driver's pre-registered phone number or mobile application.

During the construction and installation of existing parking management systems, a large number of sensors need to be installed, requiring substantial financial and time investments, thereby significantly increasing development, construction, and maintenance costs. Secondly, since most parking lots are not equipped with parking management systems, the application scenarios of this parking space notification service are limited. Finally, different parking lots may be equipped with different parking management systems, requiring each driver to register with a plurality of corresponding systems to activate the parking space notification service. This process typically involves extensive manual operations, such as pre-registration, pre-connection, triggering, selecting notification mechanisms, or other complex operations, resulting in significant inconvenience for drivers.

Therefore, there is an urgent need to provide an automatic parking space notification system, so as to overcome the problems above.

It's to be noted that the information disclosed in Background above is merely used to enhance the understanding of the background of the present disclosure, and thus may contain information that constitutes the prior art known to those skilled in the art.

### SUMMARY

To solve the problems existing in the prior art, the present disclosure provides an automatic parking space notification system that automatically identifies and notifies parking space information, without the need for the parking lot to install a parking management system.

The automatic parking space notification system according to the present disclosure comprises: a visual information acquisition module disposed on a motor vehicle and configured to visually acquire and transmit parking space information; a first short-range wireless communication module disposed on the motor vehicle and configured to receive and transmit the parking space information transmitted by the visual information acquisition module; and a second short-range wireless communication module disposed on a mobile device and configured to establish a wireless communication connection with the first short-range wireless communication module, receive the parking space information transmitted by the first short-range wireless communication module, and store the parking space information in the mobile device.

According to an embodiment of the present disclosure, the first short-range wireless communication module comprises an NFC unit, the second short-range wireless communication module comprises an NFC unit disposed on the mobile device, and the NFC unit of the first short-range wireless communication module communicates wirelessly with the NFC unit of the second short-range wireless communication module.

According to an embodiment of the present disclosure, the automatic parking space notification system further comprises an NFC unit disposed on a motor vehicle electronic key, wherein the NFC unit on the motor vehicle electronic key is configured to receive and store the parking space information and share the parking space information with a designated mobile device.

According to an embodiment of the present disclosure, the first short-range wireless communication module is disposed on a door of a driver's seat of the motor vehicle.

According to an embodiment of the present disclosure, the visual information acquisition module comprises a camera; the camera is configured to acquire an image and/or video of a parking space as the parking space information, and the camera may begin to acquire images and/or videos of the parking space when parking of the motor vehicle begins.

According to an embodiment of the present disclosure, the visual information acquisition module may further comprise an identification unit which is configured to identify text and/or numerical information in the image and/or video as the parking space information.

According to an embodiment of the present disclosure, once an engine of the motor vehicle is turned off, the first short-range wireless communication module transmits the parking space information to the second short-range wireless communication module, and the second short-range wireless communication module receives the parking space information and stores the parking space information in the mobile device.

According to an embodiment of the present disclosure, the mobile device is an NFC-enabled mobile phone, smartwatch, wristband, or tablet.

The automatic parking space notification system according to the present disclosure does not require the parking lot to install an additional parking management system, and enables the automatic acquisition, identification, and transmission of parking space information, which not only enhances the convenience and efficiency for drivers, but also effectively reduces the development, construction, and maintenance costs of a parking lot.

### BRIEF DESCRIPTION OF THE DRAWINGS

The described and other features of the present disclosure are illustrated below in detail with reference to the particular example embodiments shown in the drawings. The example embodiments are given herein by way of illustration and thus do not limit the present disclosure, and in the drawings:

FIG. 1 shows a schematic diagram of an automatic parking space notification system according to one embodiment of the present disclosure.

FIG. 2 shows a schematic diagram of an automatic parking space notification system according to another embodiment of the present disclosure.

### DESCRIPTION OF REFERENCE NUMBERS

100, 100′ Automatic parking space notification system
1, 1′ Visual information acquisition module
2, 2′ First short-range wireless communication module
3, 3′ Second short-range wireless communication module
31′ NFC unit on driver's mobile device
32′ NFC unit on motor vehicle electronic key
4′ NFC-enabled device

### DETAILED DESCRIPTION OF THE EMBODIMENTS

The present disclosure is described below in detail through particular embodiments to enable those of ordinary skill in the art to readily practice the present disclosure according to the disclosure of this description. The embodiments described below are only part, but not all, of the embodiments of the present disclosure. All other embodiments obtained by those of ordinary skill in the art on the basis of the embodiments described in the description without creative effort shall fall within the scope of protection of the present disclosure. It should be noted that the embodiments and the features in the embodiments in the description can be combined with each other under the circumstances that there is no conflict.

The terms as used herein are only used for the purpose of illustrating particular embodiments, instead of limiting the present disclosure. Unless otherwise particularly indicated in the context, the single form of “a”, “an” and “the” as used herein also include the plural form of “a plurality of”, “multiple” and “these”. The words such as “first”, “second”, etc. as used herein are merely used to distinguish between different features, steps, operations, elements and/or components, etc., but neither represent any specific technical meaning nor represent a necessary logical sequence therebetween. The word “a plurality of” as used herein may refer to two or more, and the word “at least one of” may refer to one, two or more. Any feature, step, operation, element and/or component as mentioned herein may be generally construed as one or more features, steps, operations, elements and/or components unless otherwise specifically indicated in the context. It should also be understood that the words “comprise” and/or “include” as used herein refer to the presence of the described feature, step, operation, element and/or component, but do not preclude the presence or addition of one or more other features, steps, operations, elements, components and/or sets thereof. The word “and/or” as used herein includes any or all combinations of one or more listed relevant items. The suffixes “module” and “unit” to elements herein are merely used for ease of description as they can be used interchangeably and do not have any distinguishing meaning or function.

For the prior art correlated to the illustration of the present disclosure that is apparent to those skilled in the art, detailed description thereof is omitted. It should also be understood that the description of all embodiments in this description focuses on the differences among them, and the reference may be made to each other for the same or similar points among the embodiments, which are no longer repeated herein for brevity.

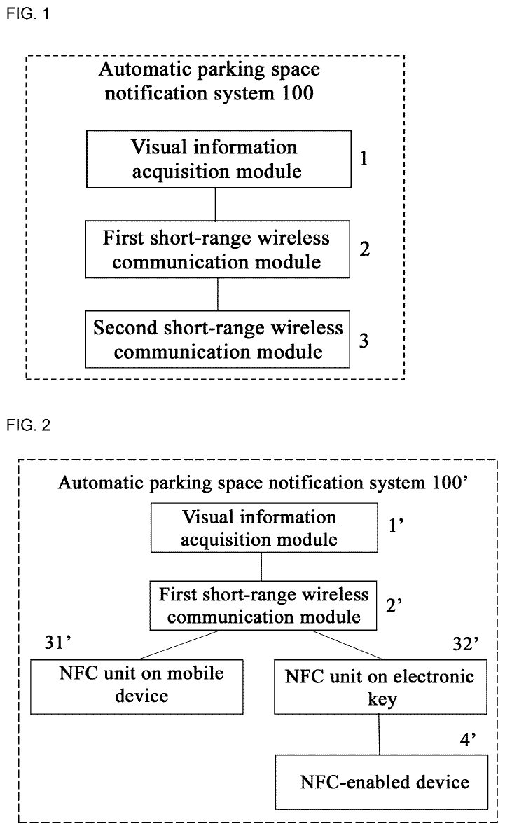

As shown in FIG. 1, the automatic parking space notification system 100 according to the present disclosure comprises a visual information acquisition module 1, a first short-range wireless communication module 2, and a second short-range wireless communication module 3. The visual information acquisition module 1 is disposed on a motor vehicle and is configured to visually acquire and transmit parking space information. According to one embodiment of the present disclosure, the visual information acquisition module 1 may comprise a camera that is either pre-installed or additionally mounted on the motor vehicle itself. The camera is configured to acquire an image and/or video of a parking space, and the image and/or video of the parking space acquired by the camera can be directly used as the parking space information. The camera may preferably comprise one or more of a front-view camera, a top-view camera, and a rear-view camera on the motor vehicle. The camera of the present disclosure adopts any existing camera installed on the motor vehicle without the need to introduce additional cameras or sensors, thereby not only reducing installation costs but also enhancing the applicability of the automatic parking space notification system. The camera of the present disclosure preferably begins to acquire images and/or videos of the parking space when parking of the motor vehicle begins. For example, during parking processes such as reversing, automatic parking, and parking guidance, the front-view camera, top-view camera, and rear-view camera detect, identify, and acquire the image and/or video parking space information.

According to another embodiment of the present disclosure, the visual information acquisition module 1 may further comprise an identification unit. The identification unit is configured to identify text and/or numerical information in the image and/or video acquired by the camera, wherein the text and/or numerical information can also be used as the parking space information. The identification unit may identify text and/or numerical information from the video captured by the camera, preferably using computer vision and pattern identification techniques. The video and/or image information and the text and/or numerical information that can be identified from the image and/or video acquired by the camera are synchronously transmitted to the driver′ mobile device. The driver can then locate the specific position or ID of the parking space according to this information. Compared to standalone image information, text and/or numerical information is more intuitive and convenient. The identification unit can achieve the identification of text and/or numerical information through the prior art, and the novelty of the present disclosure does not lie in this aspect, so no further explanation is provided. The identification unit is configured to identify text and/or numerical information in the image and/or video as the parking space information.

The first short-range wireless communication module 2 is also disposed on the motor vehicle and configured to receive and transmit the parking space information transmitted by the visual information acquisition module 1. The second short-range wireless communication module 3 is disposed on a mobile device and configured to establish a wireless communication connection with the first short-range wireless communication module 2, receive the parking space information transmitted by the first short-range wireless communication module 2, and store the parking space information in the mobile device.

When in use, the first short-range wireless communication module 2 installed on the motor vehicle automatically identifies the second short-range wireless communication module 3 on the mobile device carried by the driver and establishes a wireless communication connection with the second short-range wireless communication module. During parking in a parking lot, the visual information acquisition module 1 captures and acquires parking space information. Once the vehicle is completely parked, the first short-range wireless communication module 2 transmits the parking space information to the second short-range wireless communication module 3, and the second short-range wireless communication module 3 stores the parking space information in the driver's mobile device. The driver can easily and quickly access the parking space information, thereby achieving automatic acquisition, identification, and transmission of the parking space information.

To avoid erroneous connections between the first short-range wireless communication module 2 and near-field communication devices other than the motor vehicle, the first short-range wireless communication module 2 may comprise an NFC unit, and the second short-range wireless communication module 3 may comprise an NFC unit disposed on the mobile device. The NFC unit of the first short-range wireless communication module 2 can communicate wirelessly with the NFC unit of the second short-range wireless communication module 3. When the second short-range wireless communication module 3 is inside the motor vehicle, a near-field communication (NFC) connection may preferably be established with the first short-range wireless communication module 2. More preferably, the first short-range wireless communication module 2 is disposed on a door of a driver's seat of the motor vehicle. When the driver enters the motor vehicle, the first short-range wireless communication module 2 can quickly and accurately identify and connect with the second short-range wireless communication module 3 near the driver's seat, avoiding erroneous connections with other passengers' mobile devices having near-field communication functions.

In particular, in the embodiment, the first short-range wireless communication module 2, disposed on the door of a driver's seat of the motor vehicle, preferably performs the following three identification verifications with the second short-range wireless communication module 3 on the mobile device:

First identification verification: Once a door unlocking signal is transmitted, the first short-range wireless communication module 2 on the driver's side door is activated to pair and establish a connection. In the embodiment, the first short-range wireless communication module 2 is an NFC unit. It will be understood by those skilled in the art that the communication range of the NFC is typically 0 to 20 cm. Therefore, when the second short-range wireless communication module 3 on the driver's mobile device approaches the first short-range wireless communication module 2 on the door of a driver's seat, the two modules can establish an initial connection. The information of the mobile device that makes the initial connection is recorded by a backend system and is identified as a device that enters the vehicle through the door of a driver's seat.

Second identification verification: When the driver sits down, the pressure sensor on the driver's seat sends a signal to activate the NFC verification mechanism of the first short-range wireless communication module 2, continuously identifying and verifying whether the NFC unit 3 on the driver's mobile device can establish a connection again. The mobile device that can establish a secondary connection at this point is identified as a driver-side device inside the vehicle.

Third identification verification: Once the vehicle is turned off, the NFC verification mechanism of the first short-range wireless communication module 2 is activated for the third time to verify whether the NFC unit 3 on the driver's mobile device, which has already established a connection, can establish a connection for the third time. The NFC verification and connection establishment are continued until a vehicle door locking signal is received. At this point, the mobile device that can establish a third connection is identified as a mobile device that exits the vehicle through the driver's side door.

Subsequently, the system triggers the parking space information transmission mechanism to, according to the NFC verification and the three connection records of the first short-range wireless communication module 2, confirm and identify the mobile device carried by the driver, and then transmit the parking space information to the driver's NFC-enabled mobile phone, smartwatch, wristband, tablet, or other mobile devices.

Certainly, installing the first short-range wireless communication module 2 on a door of a driver's seat is merely one preferred solution for the placement. Those skilled in the art may further install the first short-range wireless communication module 2 at any position that facilitates establishing a near field communication connection with the driver's mobile device, for example, on a driver's seat, an instrument panel, or the like. The first short-range wireless communication module and the second short-range wireless communication module of the present disclosure can also perform wireless communication via Bluetooth, RFID, and the like.

To accurately transmit the final parking position to the driver's mobile device and avoid interference from irrelevant parking space information generated during a parking process, the first short-range wireless communication module 2 of the present disclosure preferably transmits the parking space information to the second short-range wireless communication module 3 once the engine of the motor vehicle is turned off. The second short-range wireless communication module 3 then receives and stores the parking space information in the mobile device, allowing the driver to access the parking space information at any time.

To further enhance the information expandability of the automatic parking space notification system, as shown in FIG. 2, the second short-range wireless communication module 3′ of the present disclosure preferably comprises one or two of an NFC unit 31′ disposed on the driver's mobile device and/or an NFC unit 32′ disposed on the motor vehicle electronic key. Those skilled in the art should understand that the second short-range wireless communication module 3′ can accommodate a greater number of NFC units according to actual needs, and the NFC units can be installed on different mobile devices according to specific circumstances. The mobile device in the embodiment is preferably a mobile phone. However, the present disclosure is not limited to mobile phones and may also comprise any other mobile devices that are convenient for the driver to view information, such as an NFC-enabled smartwatch, wristband, tablet, or other mobile devices.

As a preferred solution of the present disclosure, the NFC unit 32′ on the motor vehicle electronic key is configured to receive and store the parking space information and share the parking space information with a designated mobile device. When the driver needs to be changed, the relevant parking space information can be directed and shared with the NFC-enabled device of the changed driver through the NFC unit 32′ on the electronic key. This enables the expanded transmission of parking space information, allowing the changed driver to quickly access the parking space information.

To further explain the present disclosure, with reference to FIG. 2, it shows a schematic diagram of an automatic parking space notification system according to another embodiment of the present disclosure. When the driver enters the vehicle, the first short-range wireless communication module 2′ automatically identifies the NFC unit 31′ on the driver's mobile device and establishes an NFC connection. When parking begins (for example, reversing, automatic parking, parking guidance, or other operations begin), the visual information acquisition module 1′ of the motor vehicle begins to capture and acquire images comprising text and/or numerical identifiers as parking space information. Alternatively, the identification unit performs image processing and computer vision identification on the acquired images comprising text and/or numerical identifiers, and the identified information, such as parking space ID number, size, direction, and area number and/or floor number is used as parking space information. Once the vehicle is completely parked, the first short-range wireless communication module 2′ can store in a temporary memory of the motor vehicle the parking space information acquired by the visual information acquisition module 1′. Once the engine of the motor vehicle is turned off (stalled), the first short-range wireless communication module 2′ transmits the parking space information to the NFC unit 31′ on the driver's mobile device and/or the NFC unit 32′ on the motor vehicle electronic key through an NFC connection. The NFC unit 31′ stores the parking space information in the current driver's mobile device, allowing the current driver to access through his own mobile device various types of parking space information such as images and/or videos, and/or text/numbers of the parking space. In the present disclosure, when the driver needs to be changed, the parking space information can also be shared directionally with other NFC-enabled devices 4′ through the NFC unit 32′ on the electronic key, allowing other people to access the parking space information and enabling the expanded transmission of the parking space information.

According to the technical solution of the present disclosure, there is no need to install an additional parking management system in the parking lot. This solution is suitable for any indoor or outdoor parking lot and enables fully automatic acquisition, identification, and transmission of parking space information without any manual operations, such as pre-registration, pre-connection, triggering, and selecting notification mechanisms. The automatic parking space notification system according to the present disclosure has wide applicability, which not only enhances the convenience and efficiency for drivers, but also effectively reduces the development, construction, and maintenance costs of a parking lot.

In the present disclosure, the parking space information captured can be stored in the current driver's NFC-enabled mobile device and/or NFC-based electronic key. The relevant parking space information can be shared with other NFC-enabled devices through the NFC-based electronic key directionally, allowing the changed driver to quickly access the parking space information, thereby enabling the expanded transmission of the parking space information.

In the present disclosure, the camera installed on the motor vehicle can be utilized as a visual information acquisition module to acquire parking space information without installing additional cameras or sensors. The camera installation has low requirements for hardware of the motor vehicle and is applicable to a wide range of models, thus reducing development, installation, and maintenance costs.

It is to be understood that the structures shown in the drawings are merely schematic and may comprise more or fewer modules or assemblies than those shown in the drawings, or have a configuration different from that shown in the drawings. It is worth noting that when the present disclosure is implemented with embodiments that are not exhaustive in the description, those skilled in the art can make adaptive adjustments to the structure, position, or functionality settings of related components.

It is to be understood that, where technically feasible, the technical features listed above for different embodiments can be combined with each other to form additional embodiments within the scope of the present disclosure. Furthermore, the specific examples and embodiments described herein are non-limiting, and corresponding modifications can be made to the structures, dimensions, and materials described above without departing from the scope of protection of the present disclosure.

In the present application, the use of a contrasting conjunction is intended to comprise a conjunction. The use of definite or indefinite articles is not intended to indicate cardinality. In particular, references to “the” object or “an” and “one” object are intended to represent one possible of a plurality of such objects. Furthermore, rather than a mutually exclusive solution, the conjunctive “or” can be used to convey concurrent features. In other words, the conjunction “or” should be understood to comprise “and/or”. The term “comprise” is inclusive and has the same scope as “include”.

The embodiments described above, in particular any “preferred” embodiments, are possible examples of implementations and are presented solely to provide a clearer understanding of the principles of the present disclosure. Many changes and modifications may be made to the embodiments described above without substantially departing from the spirit and principles of the techniques described herein. All modifications are intended to be comprised within the scope of the present disclosure.

All documents as mentioned in the description may be cited in the present application as references as if each of them is cited in the description as a reference in its entirety.

Furthermore, it should be understood that, upon reading the description of the present disclosure, those skilled in the art may make various changes or modifications to the present disclosure, and such equivalents shall fall within the scope of protection of the present disclosure as well.

1. An automatic parking space notification system, comprising:
a visual information acquisition module disposed on a motor vehicle and configured to visually acquire and transmit parking space information;
a first short-range wireless communication module disposed on the motor vehicle and configured to receive and transmit the parking space information transmitted by the visual information acquisition module; and
a second short-range wireless communication module disposed on a mobile device and configured to establish a wireless communication connection with the first short-range wireless communication module, receive the parking space information transmitted by the first short-range wireless communication module, and store the parking space information in the mobile device.

2. The automatic parking space notification system according to claim 1, wherein the first short-range wireless communication module comprises an NFC unit, the second short-range wireless communication module comprises an NFC unit disposed on the mobile device, and the NFC unit of the first short-range wireless communication module communicates wirelessly with the NFC unit of the second short-range wireless communication module.

3. The automatic parking space notification system according to claim 2, further comprising an NFC unit disposed on a motor vehicle electronic key, wherein the NFC unit on the motor vehicle electronic key is configured to receive and store the parking space information and share the parking space information with a designated mobile device.

4. The automatic parking space notification system according to claim 1, wherein the first short-range wireless communication module is disposed on a door of a driver's seat of the motor vehicle.

5. The automatic parking space notification system according to claim 1, wherein the visual information acquisition module comprises a camera which is configured to acquire an image and/or video of a parking space as the parking space information.

6. The automatic parking space notification system according to claim 5, wherein the visual information acquisition module further comprises an identification unit which is configured to identify text and/or numerical information in the image and/or video as the parking space information.

7. The automatic parking space notification system according to claim 5, wherein the camera begins to acquire images and/or videos of the parking space when parking of the motor vehicle begins.

8. The automatic parking space notification system according to claim 1, wherein once an engine of the motor vehicle is turned off, the first short-range wireless communication module transmits the parking space information to the second short-range wireless communication module, and the second short-range wireless communication module receives the parking space information and stores the parking space information in the mobile device.

9. The automatic parking space notification system according to claim 8, wherein the mobile device is an NFC-enabled mobile phone, smartwatch, wristband, or tablet.
